(19) United States
(12) Patent Application Publication
(10) Pub. No.: US 2018/0189501 A1
(43) Pub. Date: Jul. 5, 2018

(54) SYSTEM AND METHOD OF TRANSFERRING DATA FROM A CLOUD-BASED DATABASE TO A PRIVATE NETWORK DATABASE FOR LONG-TERM STORAGE

(71) Applicants: KOSEI OGAWA, TOKYO (JP); BENJAMIN MAXWELL COLLINS, TOKYO (JP)

(72) Inventors: KOSEI OGAWA, TOKYO (JP); BENJAMIN MAXWELL COLLINS, TOKYO (JP)

(21) Appl. No.: 15/396,020

(22) Filed: Dec. 30, 2016

(51) Int. Cl. G06F 21/60; G06F 17/30; H04L 29/08; H04L 29/06; G06F 21/62

(52) U.S. Cl. CPC G06F 21/602; G06F 17/303; H04L 67/10; G06F 2221/2107; H04L 63/0471; H04L 63/06; G06F 21/6245; H04L 63/083

(57) ABSTRACT

A system and method for the protection of sensitive information by transferring data from a cloud-based database to a private network database for long-term storage is presented. The system includes an online cloud endpoint having a cloud application database and a cloud temporary database for the selective storage of information. Additionally it includes an electronic device configured to capture and transmit information related to a user, the information received by the online cloud endpoint. Furthermore it includes a local private application server configured to selectively request information from the online cloud endpoint.

### BACKGROUND

### 1. Field of the Invention

The present application relates to a system for storing information, and more particularly to a system and network configuration for transferring data from a Cloud-based database to a Database on a private network for long-term storage.

### 2. Description of Related Art

Personally identifiable information (PII) as used in US privacy law and information security, is information that can be used on its own or with other information to identify, contact, or locate a single person, or to identify an individual in context. Examples include any and all of the following: Full name (if not common); Home address; Email address (if private from an association/club membership, etc.); National identification number; Passport number; IP address (when linked, but not PII by itself in US); Vehicle registration plate number; Driver's license number; Face, fingerprints, or handwriting; Credit card numbers; Digital identity; Date of birth; Birthplace; Genetic information; Telephone number; and Login name, screen name, nickname, or handle.

The National Institute of Standards and Technology has Guidelines for how to properly manage Personally Identifiable Information. One of those guidelines is to “de-identify” information or obscure information in such a way that not all of the information is identifiable.

When creating web applications, it is often necessary to collect Personally Identifiable Information in order to provide a service over the internet. The service maybe to deliver some physical product to the person's address, require a credit card for payment, or other information depending on the type and needs of the service.

This personally identifiable information is often kept in the cloud for these services as it is often required for the user to be able to view, edit or confirm their information, and otherwise required for the information to be in such a location as to be able to fulfill the service the application provides.

This leads to a problem as while the user is able to view and edit their information, when information is exposed to the internet there are any number of attacks, such as session hijacking, script injection, zero day attacks, denial of services attacks or otherwise which might allow this information to leak. One way to minimize liability and still allow for users to interact with online services is to de-identify the information so that only part of any personally identifiable information is obscured when stored on the cloud, with another complete set of the private information in on a private network for any orders to actually be processed.

Although strides have been made to increase security with respect to personal identifiable information, shortcomings remain. A system and method for de-identifying information is needed to prevent the loss of information during a cyber-attack.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a graphic of a system of transferring data from a cloud-based database to a private network database for long-term storage according to an embodiment of the present application.

FIG. 2 is an expanded graphic of a cloud endpoint in the system of FIG. 1.

FIG. 3 is an alternate graphic showing the system of FIG. 1.

FIG. 4 is a graphic of a user device used in the system of FIG. 1

FIG. 5 is a graphic of a server in the system of FIG. 1.

FIGS. 6-12 are a series of schematics of the process of using the system of FIG. 1.

FIGS. 13-15 are a series of schematics of a transfer process between the cloud endpoint of FIG. 2 and a physical terminal in the system of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with traditional security devices for doors. In particular, the system is configured to selectively transmit information from an online cloud endpoint to a local private application server for the protected and long-term storage of such information. By not storing sensitive information online for long periods of time, dangers associated with cyber-attacks are minimized. These and other unique features of the device are discussed below and illustrated in the accompanying drawings.

The system and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system and method of the present application is illustrated in the associated drawings. The system includes an online cloud endpoint having a cloud application database and a cloud temporary database for the selective storage of information. Additionally it includes an electronic device configured to capture and transmit information related to a user, the information received by the online cloud endpoint. Furthermore it includes a local private application server configured to selectively request information from the online cloud endpoint. Additional features and functions of the device are illustrated and discussed below.

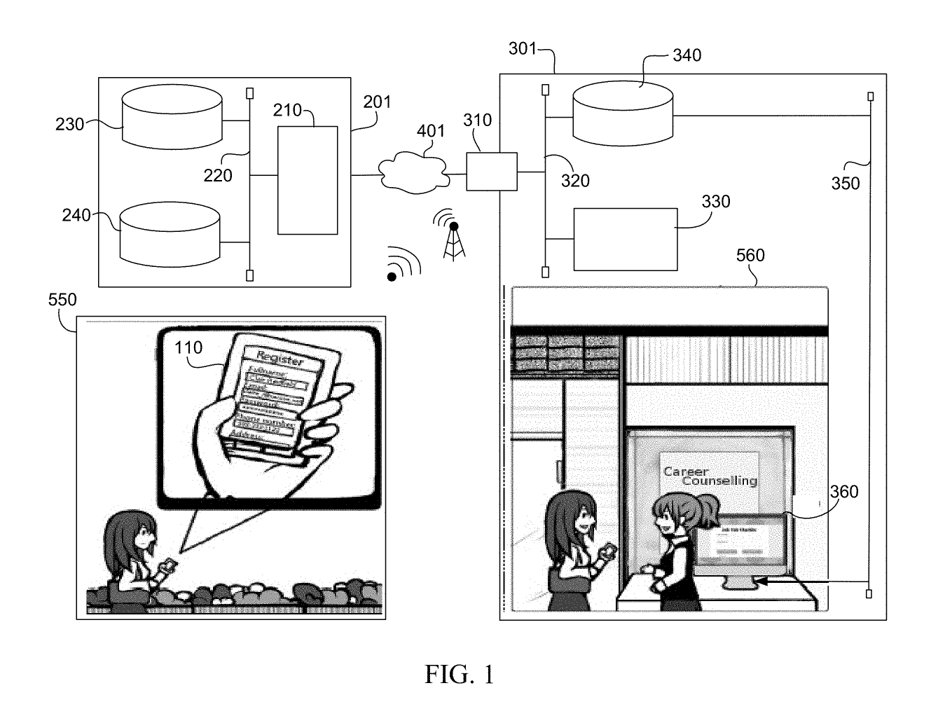

Referring now to the drawings wherein like reference characters identify corresponding or similar elements in form and function throughout the several views. In FIG. 1, a graphic of a system of transferring data from a cloud-based database to a private network database for long-term storage in accordance an embodiment of the present application is illustrated. This system is shown in various views and in different functions throughout the remaining several Figures. The system includes an online cloud endpoint and a 301 private facility or physical and/or local private application server 330.

An example implementation of the present system is as follows. A company provides job hunting support for students getting out of college. Students are able to register their personal information to take advantage of the company's service. These companies may provide services such as, forwarding a student's contact information and resume to a possible employer, providing consultation at a physical location, or other online services for tracking which qualification tests would be advantageous to their field, or a calendar for tracking when and where interviews are scheduled.

The student using this service expects that their personal information is being adequately managed by the company they submit it to. The company would also like to manage the data submitted to them in such a way that they can use, view and interact with the data from the backend to understand which users are taking advantage of their service, and be able to forward their user's personal information to third party companies, or contact that user individually if necessary.

The method by which this is accomplished is by not storing all of the submitted data to the cloud. The only data stored in the cloud is the bare amount of information required for the student to be able to use the service from their smart device. The rest of the data in its entirety is selectively encrypted and stored on a database in the cloud for a temporary period of time before being transferred to a private facility for long term storage, or use by the staff of the company within means of the terms and conditions stated in the license agreement for that service.

This process is depicted in FIG. 01. Panel 550 shows a student holding a smart device 110, which a register page submits their information to the company's service is displayed on the smart device's 110 web browser 140. Once the user has entered their personal information the web browser 140, the user then submits the information to the company's 210 application server. The 210 application server handles the information sent by the user by taking the minimum amount of information required for the application and inserting it into a cloud application database 230. The information submitted by the user in its entirety is encrypted by the application server 210 and inserted into the cloud temporary database 240.

In a private facility 301 a private application server 330 runs a process on a timer. That process is designed to send a request from the private application server 330 to the cloud application server 210 to authenticate and request the encrypted information in the cloud temporary database 240, and transfer it to the private database 340, subsequently deleting from the cloud temporary database 240 upon completion.

Once the user's information has been transferred to the private database 340, it can be taken advantage of by the staff of that company. This is depicted in panel 560 where the student goes to the private facility 301 or company for a consultation and the staff has relevant for the user's resume and other information.

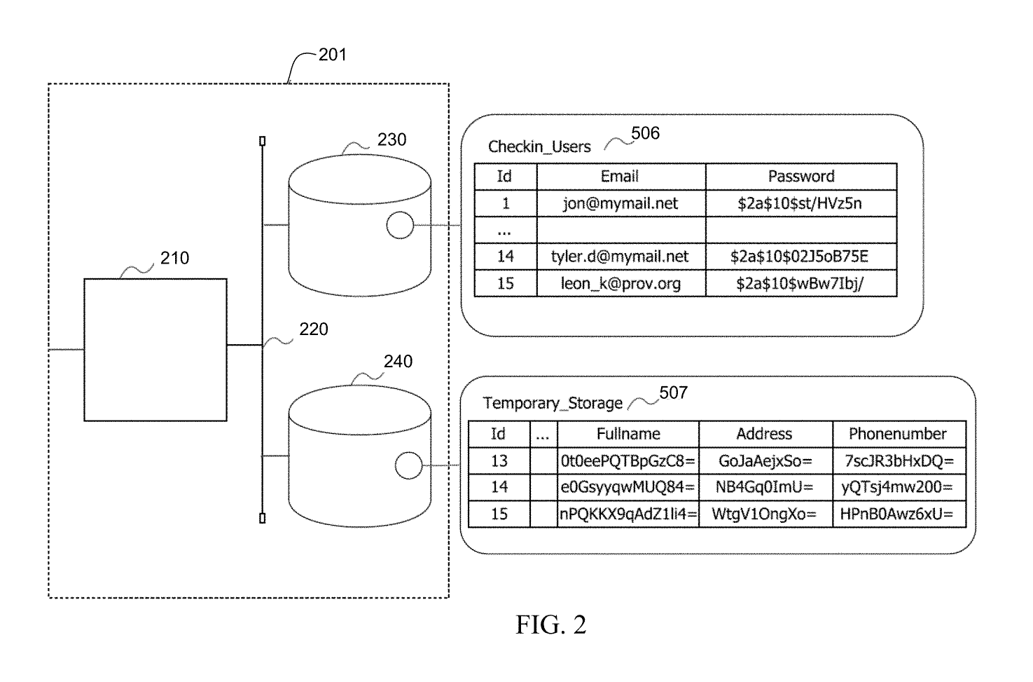

Referring now also to FIG. 2 in the drawings, the relationship between the cloud application database 230 and the cloud temporary database 240 is depicted. For example the cloud application database 230 may contain a table named Checkin_Users 506 which contains the minimal amount of information, or otherwise de-identified information for the user to still be able to use the web application. In this figure the only information contained this table is a user id, an email and a password hash for the user to identify themselves to the web application.

The cloud temporary database 240 contains the complete encrypted context of any personal identifiable information sent to the web application server 210. This figure depicts a table named Temporary_Storage 507 which contains personal identifiable information which is waiting to be transferred to the private database 340. The fields as depicted as “Full name”, “Address”, and “Phone number” are depicted as AES_256 encrypted values. Also note that the ellipses in the Temporary_Storage table 507 indicate there may be other fields such as “Email”, “Gender” or any other information which has been deemed necessary to store for the user on the private database 340.

Notice that the id field in the table 507 corresponds to the numbering of the id field in the Checkin_Users table 506. The Id field in the Checkin_User table 506 has Id's 1-15, which for the purpose of this document represents the current complete set of users. The Temporary_Storage table 507 contains Id's 13-15 which represent information from the last three registered users to the web service.

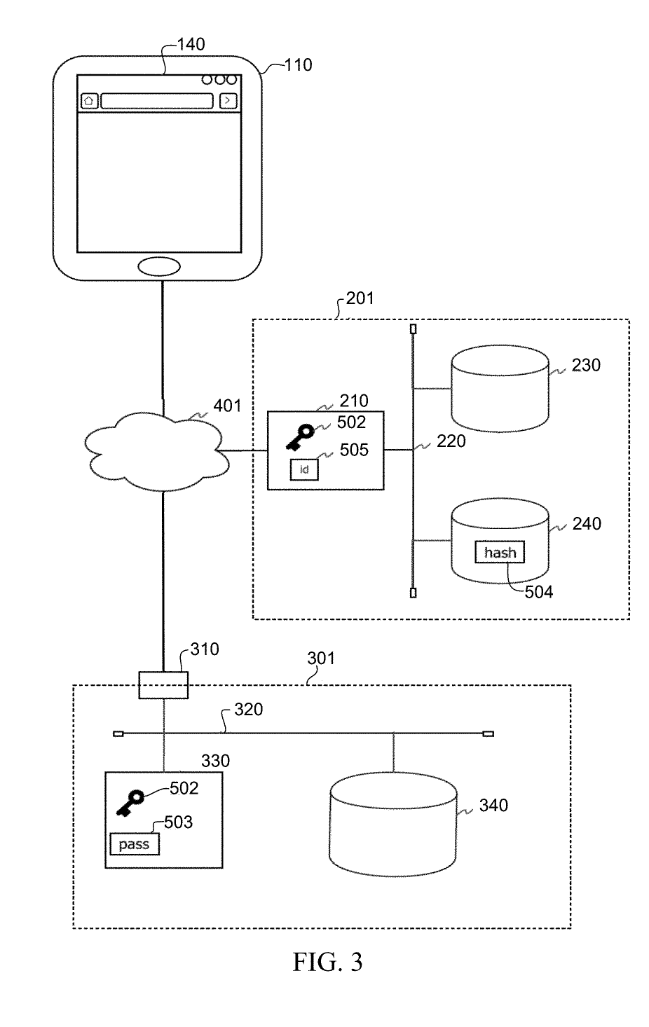

Referring now also to FIG. 3 in the drawings, the network configuration in its entirety is depicted. The end-user interacts with the present system from a smart device 110 with a web browser 140 which is connected to the cloud 401. It is understood that the smart device 110 is any electronic device configured to capture and transmit information. Any computer, personal electronic tablet, or cell phone are merely examples.

The web application to which the end-user registers to is accessible from cloud endpoint 201. The endpoint 201 contains a cloud application server 210 which handles tcp/ip based requests from the network. The cloud application server 210 contains two keys pieces of information stored on it, namely an encrypted key 502 which is used to encrypt information to be stored in the cloud temporary database 240. The other is the last id 505, or primary key of the data transferred to the private database 340.

The 201 cloud endpoint contains a cloud network 220 for communication between the cloud application database server 230 and the cloud temporary database 240. Note that while the cloud application server 210, cloud application database server 230 and cloud temporary database 240 can all be executed on the same device, internally they will communicate with each other over a local loopback network interface. This documentation defines them as separate devices by their functionality for the purpose of explanation. This patent makes no distinction for if the endpoint is comprised of one or more devices as long as they are in this configuration.

The cloud temporary database 240 contains a hash 504 of the last generated passphrase generated by the cloud application server 210 from a previous transfer.

The location in which data is transferred from the cloud temporary database 240 is to a private location facility 301. The location maybe a business, warehouse, office, data center or anywhere which is deemed adequately secure for the uses entailed. Private location facility 301 must have a router 310 which connects a private network 320 to the cloud 401.

Inside the private facility 301 is private application server 330. The device does not need to act as server, this terminology has been used as this device uses the same specifications of that of a server. It is a headless device that is able to send, receive and handle network communications over the tcp/ip protocol.

On the private application server 330 are two files, namely the same encryption key 502 as on the cloud application server 210 to decrypt data, and a passphrase 503 for authenticating the private application server 330 to the cloud application server 210.

Lastly is the private database 340 which contains sensitive information in its entirety. Similar to the 201 cloud endpoint, the private database 340 and the private application server 330 can be on the same device and communicate with each other over an internal loopback network interface. This documentation separates these as different devices by their functionality for the purpose of explanation. The present system makes no distinction if these functionalities are on one more device, only their respective relation to each other is important.

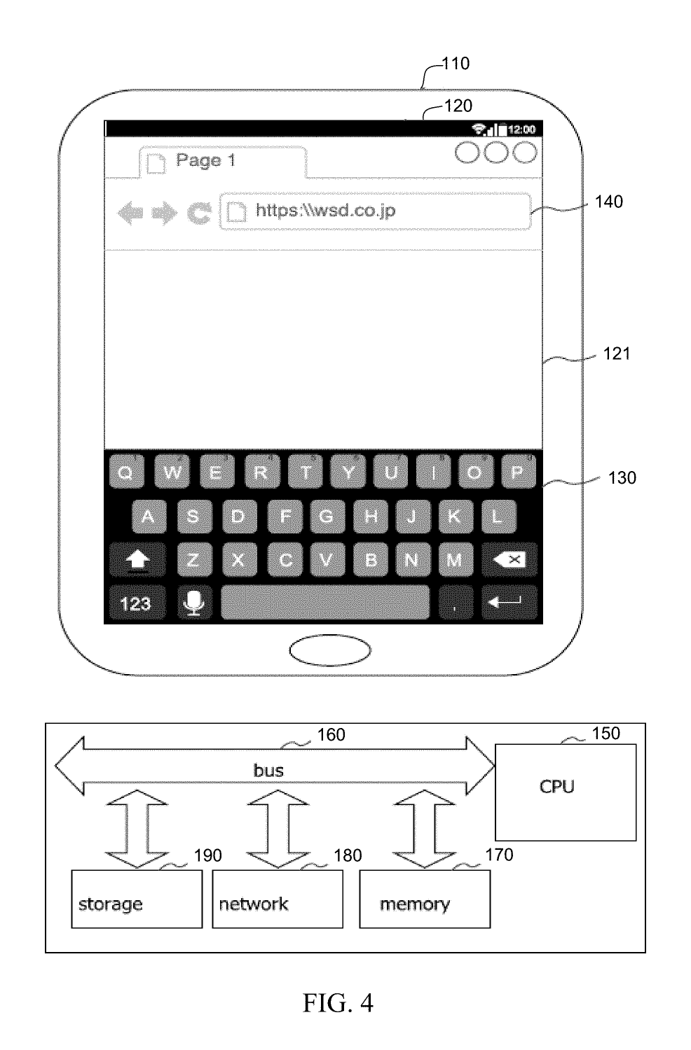

Referring now also to FIG. 4 in the drawings, a graphic of what a smart device 110 is, is depicted. Smart device 110 refers to the smart device in its entirety. Smart devices can be a wide arrange of devices included personal computers, notebooks, smartphones and tablets. The distinction this documentation makes to define these devices is that they have a screen 120 that can display information to the user. A method of a pointing device, such as a mouse (not pictured) or commonly a method of capacitive touch screen 121 which is built directly to the device which can point to an x,y location on the device as indicated by the user.

The definition also included a web browser which is able to send tcp/ip requests and get binary information using the http protocol and render it to display to the user. The device should also contain some form of text entry interface 130, such as a keyboard (not pictured) which is connected to the device. Though most smart devices with a touch interface include a method of text entry in which an on screen keyboard is displayed to the user on the screen and text input is defined by pressing the corresponding x,y location of the key on the screen.

The device should also include some form of cpu 150 which is able to run and execute computer code. Some form of memory 170 which is able to store values and computer code to be utilized by the cpu 150, a network interface 180, such as a Wi-Fi or LAN interface which allows the device to communicate with other devices over the tcp/ip protocol, and some form of non-volatile storage 190 which is able to store computer code, such as the operating system or files when the device is either off or on. And lastly a bus 180 which allows each one of these components to send information to and from the cpu 150.

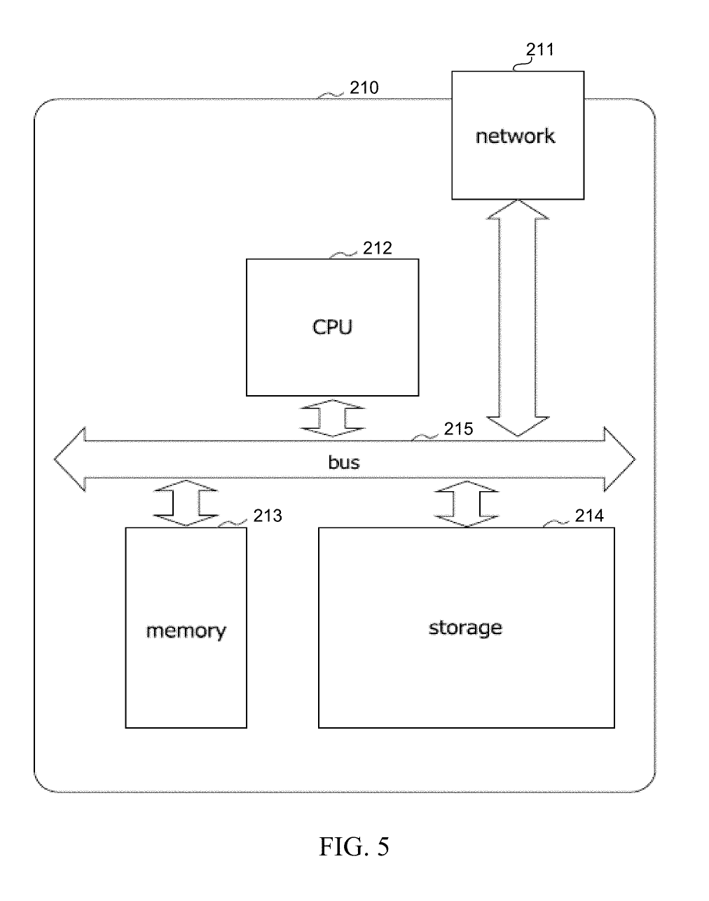

Referring now also to FIG. 5 in the drawings, an exemplary server used in the present system is depicted. A server such as the cloud application server 210 is a device with a network interface 211 which allows the device to communicate with other devices over a network using the tcp/ip protocol. The device also has a cpu 212 which is able to execute computer code, memory 213 which is able to store values and computer code to utilized by the cpu 212. Also the device should have some form of non-volatile storage 214 which can store computer code when the device is powered off or on for extended periods of time. Lastly a bus 215 is required for all of these components to communicate with the cpu 212.

Note that such requirements such as a screen or input device have not been defined for these devices as a mouse or keyboard. While it may be required for human interaction to program these devices, the functionality of these devices has no human interaction. This device definition stands for all devices in this documentation referred to either as a “server” or “database”.

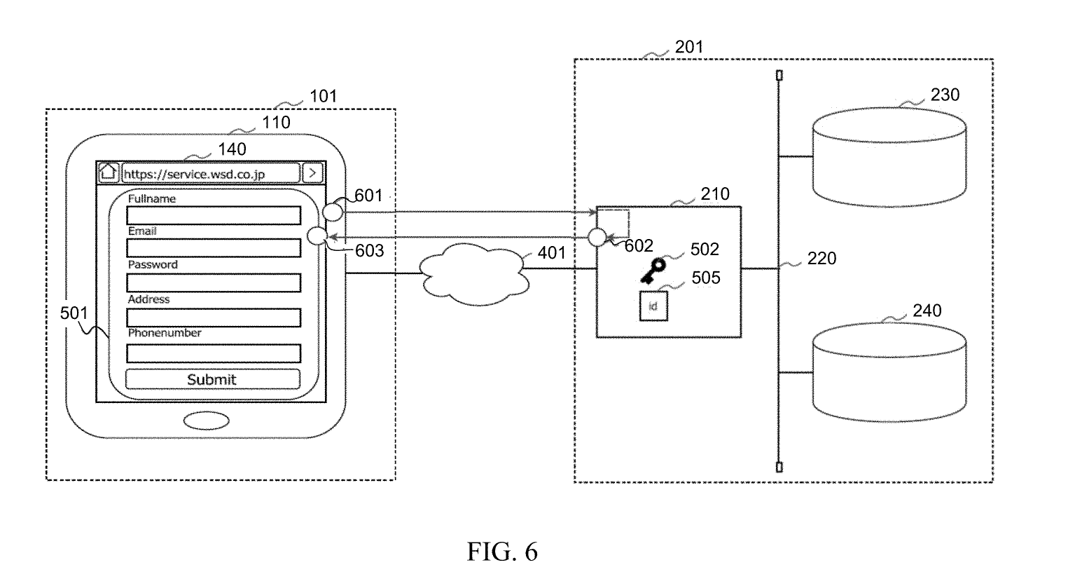

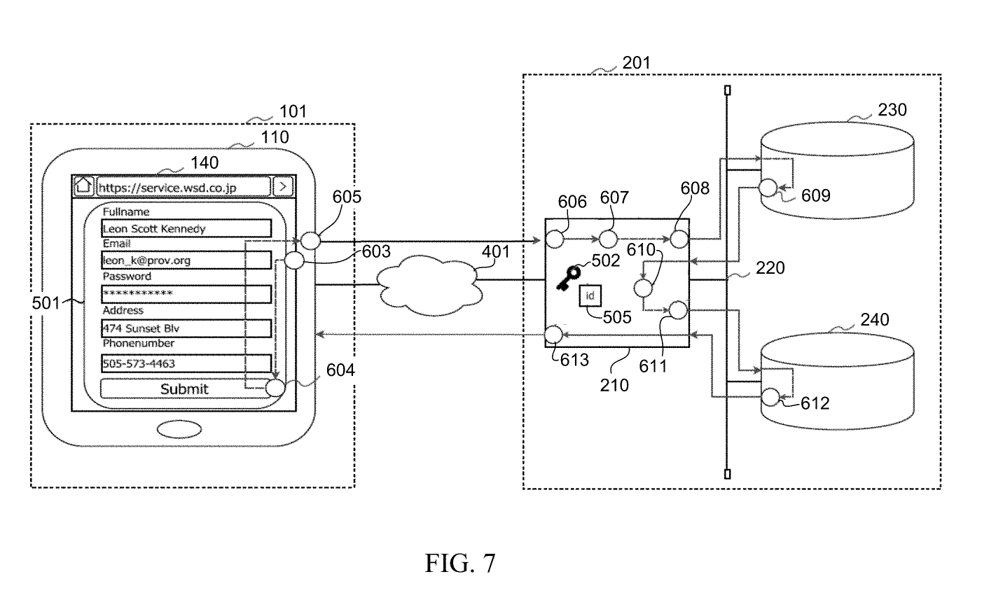

Referring now also to FIGS. 6-7 in the drawings, the process in which an end user register's their information for a web service for use with the present system is depicted. In Step 601, the user's web browser 140 sends an http request to a web server for a registration page. In Step 602, the web application server 210 accepts the request and sends a reply to the web browser client 140.

Step 603 The web browser 140 displays the contents of the page, such as a form 501 for registering user information to the web service including information, such as full name, email, password, address and phone number.

IN particular with FIG. 7, Step 604, the user enters their information and presses the submit button on the 501 registration form. In Step 605, the web browser 140 sends a post request to the 210 web application server with the user's entered information included in the body of the request. Step 606 The cloud application server 210 accepts the request and checks the enclosed information for format consistency as to not write any partial or incorrect data into the database. Step 607 The 210 cloud application takes the user entered information and makes a copy, removing personally identifiable information as much as possible to still be used with the web service.

Step 608 The cloud application server 210 sends a write request to the 230 cloud application database to write the partial user information. Step 609 The 230 cloud application database writes the partial user information and sends a confirmation response back to the cloud application server 210. Step 610 The cloud application server 210 uses the 501 data encryption key to encrypt the user's entered information in its entirety. Step 611 The cloud application server 210 sends a write request to the cloud temporary database 240 to write the encrypted data to the database. Step 612 The cloud temporary database 240 writes the information to the database and sends a confirmation response back to the application database server. Step 613 The cloud application server database 210 sends a confirmation response back to the user's web browser 140.

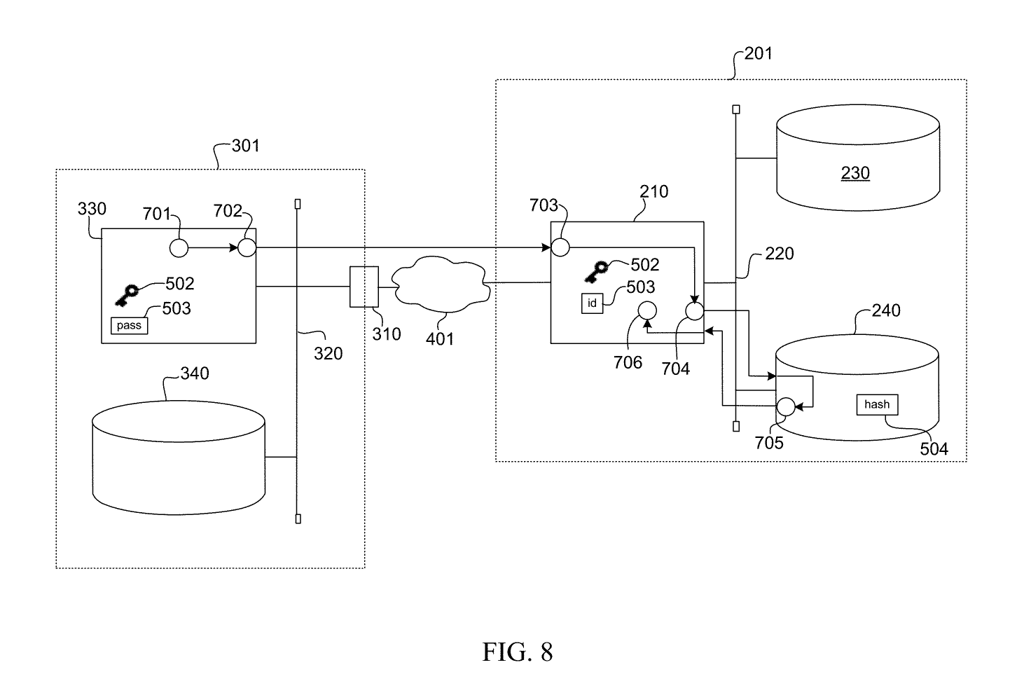

Referring now also to FIGS. 8-12 in the drawings, the process for which user information is transferred from the cloud temporary database 240 to the private database 340 is depicted. Step 701 The private application server 330 reads the passphrase 503 to authenticate itself to the cloud application server 210. Step 702 The private application server 330 sends a request to the cloud application server 210 with a request to read the encrypted data in the cloud temporary database 240 along with the current passphrase 503. Step 703 The cloud application receives 210 the request to read the user information from the cloud temporary database 240. It then needs to confirm the authenticity by checking the provided passphrase against the hash in the database.

Step 704 The cloud application server 210 sends a request to the to get the current hash 504 to authenticate the request from step 703. Step 705 The cloud temporary database 240 reads the passphrase hash 503 and returns it to the cloud application server 210. Step 706 The cloud application server 210 compares the passphrase 502 provided from the request from step 703 with the current passphrase hash 503 from the cloud temporary database 240.

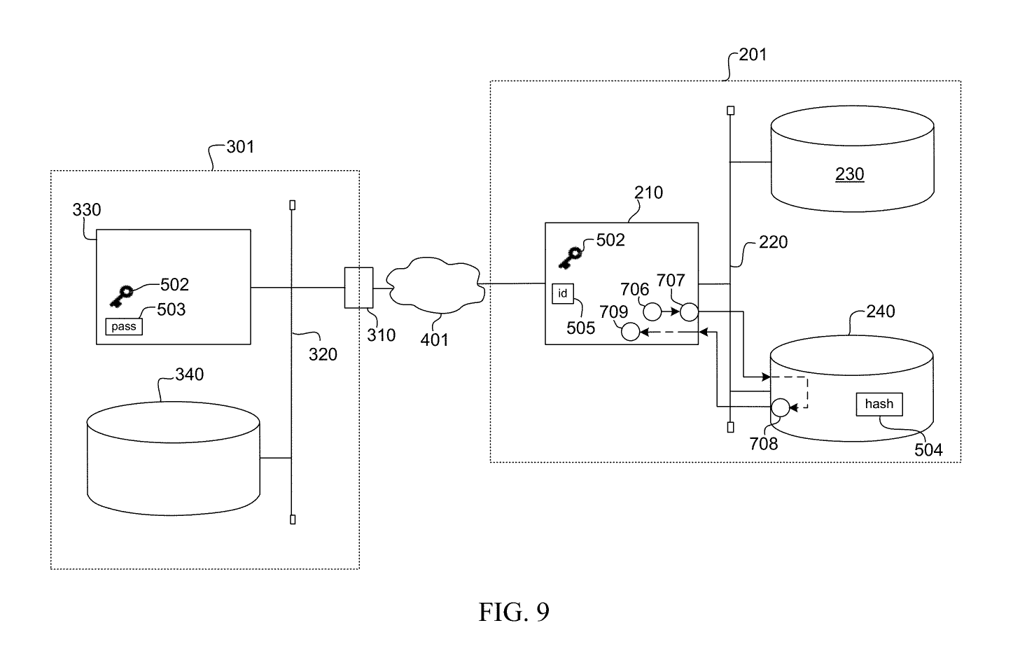

In particular with FIG. 9, Step 707 The cloud application server 210 sends a request to the cloud temporary database 240 to read all of the encrypted user data. Step 708 The cloud temporary database 240 reads all of the encrypted user data and returns it to the cloud application server 210. Step 709 The cloud application server 210 writes the id of the last read primary key id 505 to the file system.

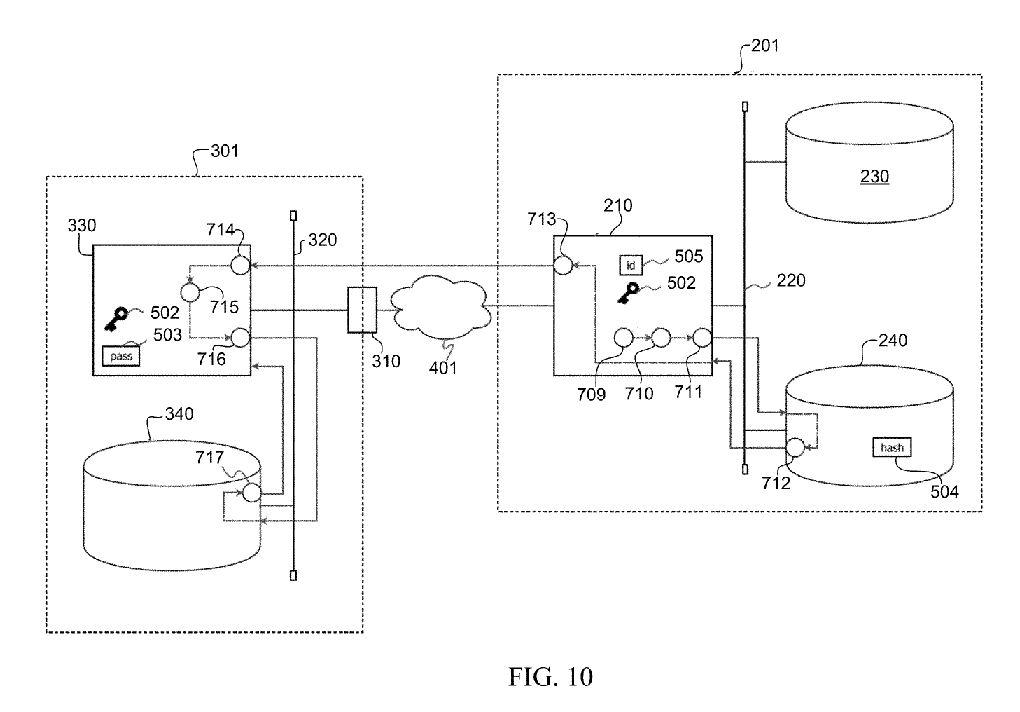

In particular with FIG. 10, Step 710 The cloud application server 210 creates a new passphrase 503 and hash 504 of the passphrase. Step 711 The cloud application server 210 sends a request to write the new passphrase hash 504 to the 240 cloud temporary storage database. Step 712 The cloud temporary database 240 sends a confirmation response back to the cloud application server 210.

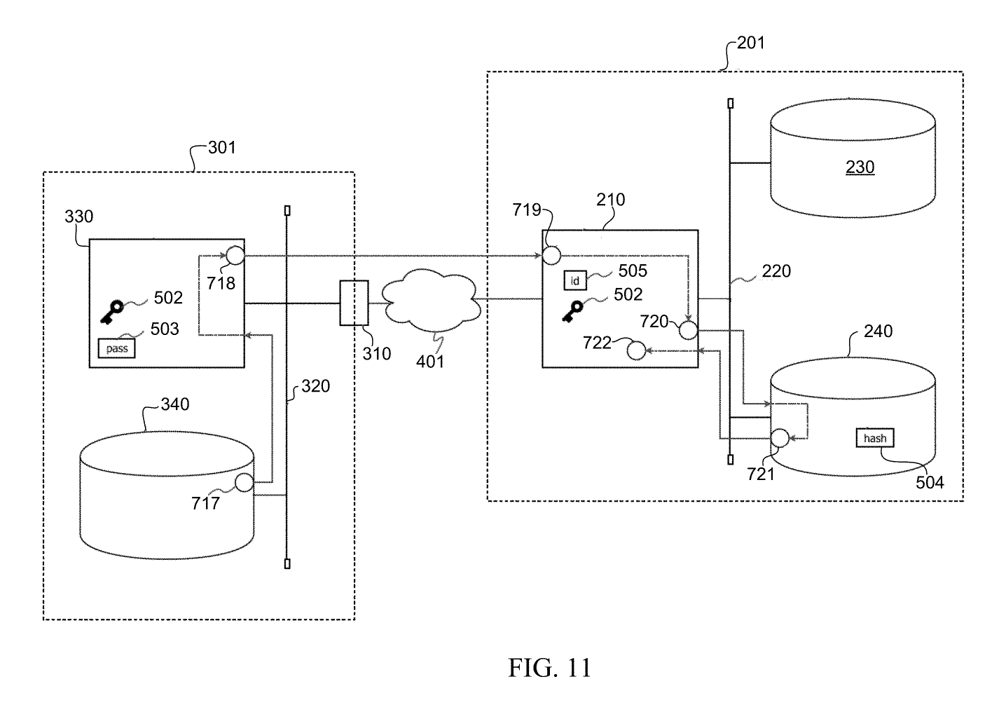

In particular with FIG. 11, Step 713 The cloud application server 210 sends a response back to the private application server 330 with a the new passphrase 503 and all of the encrypted user data included in the body of the response. Step 714 The private application server 330 receives the information from the cloud application server 210 writes the new passphrase 503 to the file system. Step 715 The private application server 330 decrypts all of the user data with the data encryption key 502. Step 716 The private application server 330 sends a write request to the private database 340 to write all of the decrypted user information to the database. Step 717 The private database 340 writes the provided user data to the database and sends a confirmation response to the private application server 330.

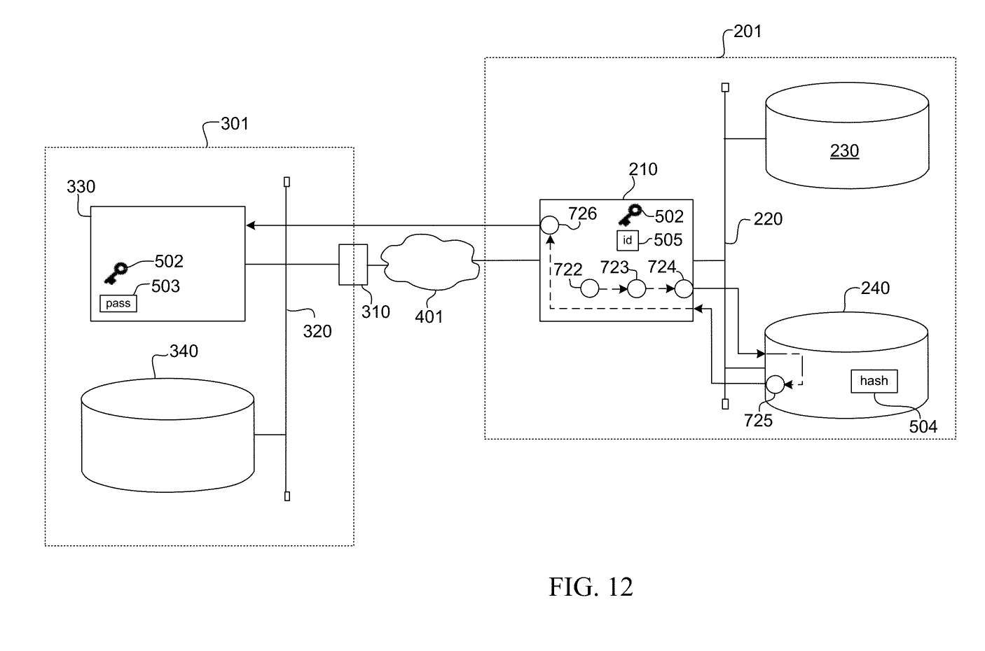

In particular with FIG. 12, Step 718 The private application server 330 reads the current passphrase 503 from the file system and sends a request to the cloud application server 210 to delete the encrypted data in the cloud. Step 719 The private application server 210 receives the requests and confirms the request is to delete the information in the cloud. Before doing so it will verify the authenticity of the request by checking the provided passphrase 503 with the passphrase hash 504 stored in the database.

Step 720 The private application server 210 sends a request to the cloud temporary database 240 for the current passphrase hash 504. Step 721 The cloud temporary database 240 reads the current passphrase hash 504 and sends the response to the cloud application server 210. Step 722 The cloud application server 210 checks the passphrase 503 from the request from Step 718 with the passphrase hash 504 from the cloud temporary database 240.

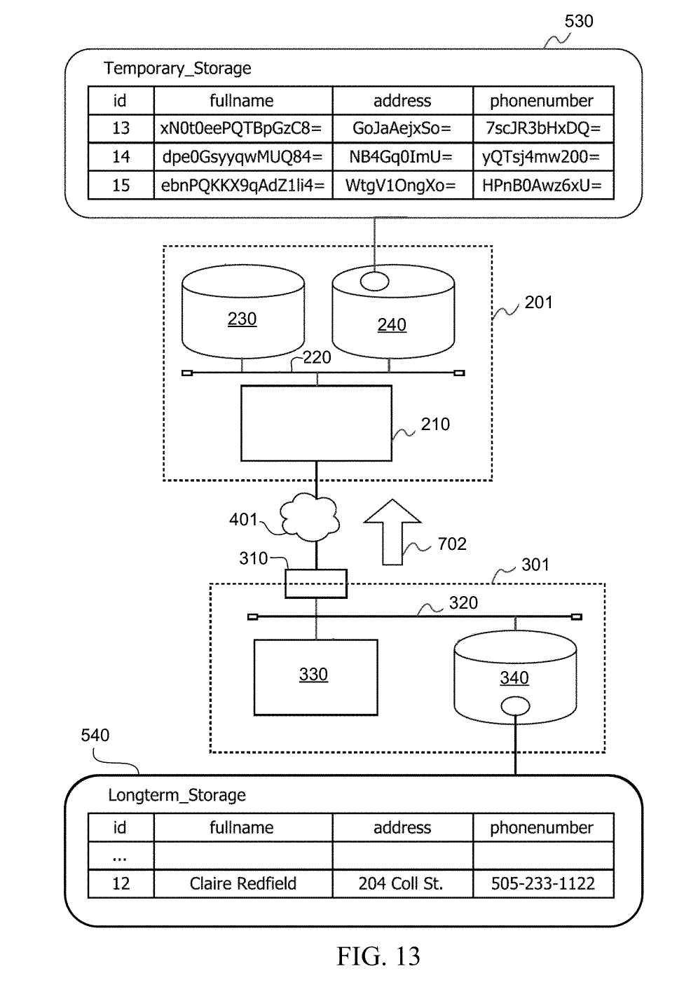

Referring now also to FIGS. 13-15 in the drawings, schematics of a transfer process between the cloud endpoint and the physical terminal in the system is depicted. Step 723 The cloud application server 210 reads the last id 505 that was sent to the private database server 330 from the file system. Step 724 The 210 cloud application sends a request to the cloud temporary database 240 to delete all of the encrypted user data up through the last id 505 that was transferred to the private application server 330. Step 725 The cloud temporary database 240 deletes the indicated data range and returns a confirmation response to the cloud application server 210. Step 726 The cloud application server 210 sends a confirmation response to the private application server 330.

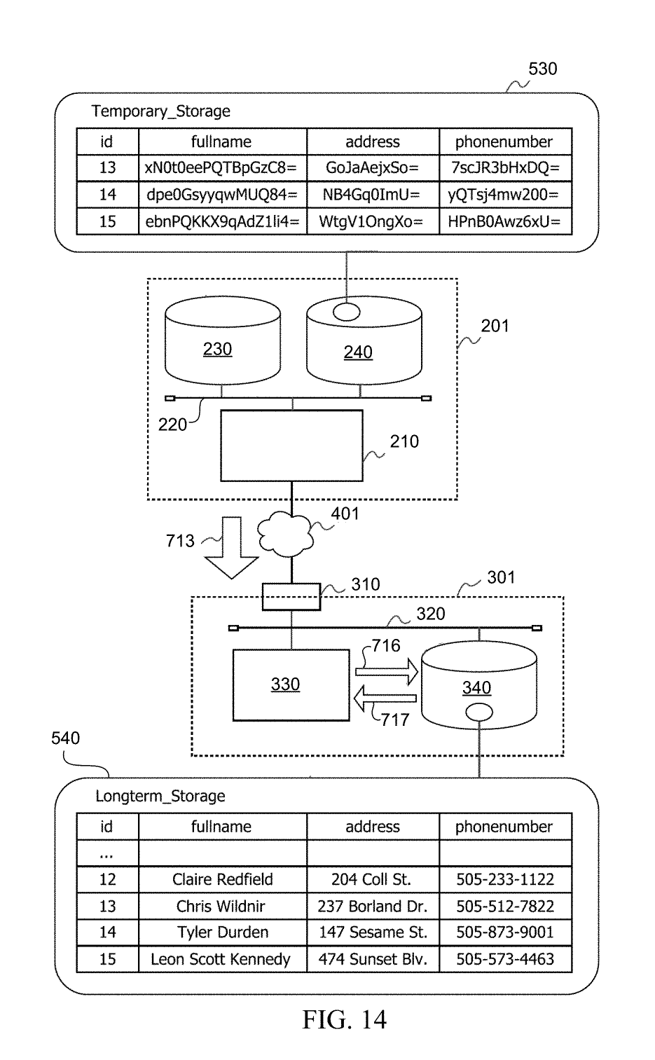

In particular with FIG. 14, the state of the cloud temporary database 240 and the private database 340 before the encrypted data is transferred from the cloud to the private facility is depicted. In this figure there are two tables depicted. Temporary Storage 530 which holds the encrypted user data temporary in the cloud and Longterm_Storage 540 which holds all of the information which has been transferred from the cloud up to that point.

Note that the “id” field of the Temporary_Storage 530 database starts at 13, and the “id” field of the Longterm_Storage 540 table has id's from 1-12, indicating all previous database has been transferred to the private database 340 on previous transfers. The arrow 702 refers to Step 702 from FIG. 08 where the private application 330 sends a request to initiate the transfer of data from the cloud temporary database 240.

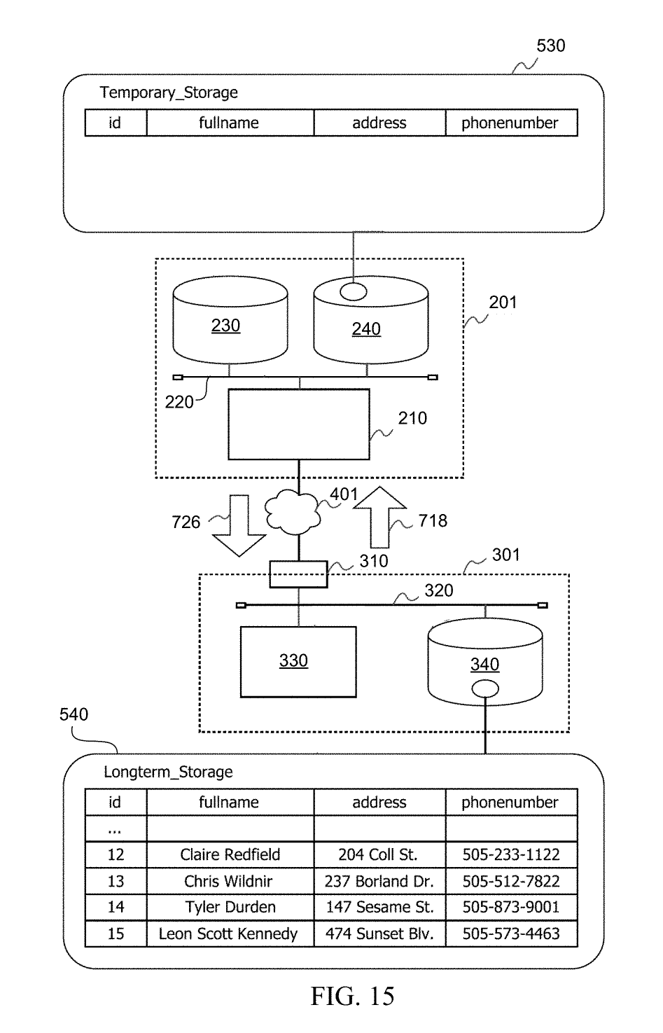

In particular with FIG. 15, the state of the cloud temporary database 240 and the private database 340 is depicted. The arrow 713 represents the response containing the encrypted user data that the cloud application server 210 sends to the private application server 330. Arrows 716 and 717 are the request and response from the private application server 330 to the private database 340 to write the unencrypted user data.

In this figure, the Temporary_Storage table 530 on the cloud temporary database 240 still contains an encrypted partial set of the data. The Longterm_Storage 540 table on the private database 340 now has the decrypted data from the cloud temporary database 240 appended to the end of the data that was present before.

The current application has many advantages over the prior art including at least the following, the ability to protect sensitive user information by temporarily storing the information in a segregated and encrypted form online and routinely transferring such information to a local host or facility for permanent storage. Only needed information for the application to identify the user is accessible while the sensitive information is kept encrypted until transferred to the local host.

A summary of the numerical identifiers are provided herein:
110—Smart Device
120—Smart Device Screen
121—pointing device
130—text entry interface
140—Smart Device Web Browser
150—Smart Device CPU
160—Smart Device Bus
170—Smart Device Memory
180—Smart Device Network Interface
190—Smart Device Non-volatile Storage
201—Cloud Endpoint
210—Cloud Application Server
220—Cloud Network
230—Cloud Application Database
240—Cloud Temporary Database
211—Server Network Interface
212—Server CPU
213—Server Memory
214—Server Non-volatile Storage
215—Server Bus
301—Private Facility
310—Private Router
320—Private Network
330—Private Application Server
340—Private Database
350—Private Network Segment
360—Personal Computer
401—Cloud
501—Registration Form
502—Data Encryption Key
503—Passphrase
504—Passphrase Hash
505—Last Transferred Id
506—Checkin_Users Table
507—Temporary_Storage Table

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An system of transferring data from a cloud-based database to a private network database for long-term storage, comprising:
an online cloud endpoint having a cloud application database and a cloud temporary database for the selective storage of information;
an electronic device configured to capture and transmit information related to a user, the information received by the online cloud endpoint; and
a local private application server configured to selectively request information from the online cloud endpoint;
wherein selective information transmitted from the online cloud endpoint to the local private application server is automatically deleted after transmission is completed.

2. The system of claim 1, wherein the online cloud endpoint includes a cloud application server configured to encrypt information received.

3. The system of claim 1, wherein the information received by the online cloud endpoint is handled so as to separate information required for the application to operate from the information personal to the user.

4. The system of claim 1, wherein personal information of the user is automatically removed from the online cloud endpoint and provided to a facility having direct access to the local private application server.

5. The system of claim 1, wherein the local private application server includes a private database for the long-term storage of user information.

6. The system of claim 1, wherein the local private application server includes a private application server configured to regulate the encryption of information passing to and from the local private application server.

7. The system of claim 1, wherein the local application server includes a timer configured to systematically initiate the request for information to be transferred from the online cloud endpoint.

8. The system of claim 1, wherein the online cloud endpoint includes a cloud application server configured to selectively regulate the encryption of information received and transmitted by the online cloud endpoint.

9. The system of claim 1, wherein the online cloud endpoint includes a cloud application server configured to include an encryption key to encrypt information to be stored in the cloud temporary database and an ID or primary key.

10. The system of claim 1, wherein the local private application server includes an encryption key to encrypt information to be stored in the local private application server and a passphrase for authenticating the local private application server to the cloud application server.

11. The system of claim 1, wherein the online cloud endpoint and the local private application server share an encryption key.
